(19) United States
(12) Patent Application Publication
(10) Pub. No.: US 2014/0205916 A1
(43) Pub. Date: Jul. 24, 2014

(54) MANUFACTURE OF MIXTURES COMPRISING LIPO2F2 AND LIPF6

(71) Applicants: Placido Garcia-Juan, Bad Honnef (DE); Alf Schulz, Wedemark (DE)

(72) Inventors: Placido Garcia-Juan, Bad Honnef (DE); Alf Schulz, Wedemark (DE)

(73) Assignee: SOLVAY SA, Brussels (BE)

(21) Appl. No.: 14/238,003

(22) PCT Filed: Jul. 31, 2012
(86) PCT No.: PCT/EP2012/064916

§ 371 Date: Feb. 10, 2014

(30) Foreign Application Priority Data
Aug. 16, 2011 (EP) 11177718.1

(51) Int. Cl. H01M 10/0568; H01M 12/02

(52) U.S. Cl. CPC H01M 10/0568; H01M 12/02
USPC 429/403; 429/199; 423/301; 428/402

(57) ABSTRACT

Mixtures comprising LiPO₂F₂ and LiPF₆ both of which are electrolyte salts or additive for, i.a., Li ion batteries, are manufactured by the reaction of POF₃ and LiF. The mixtures can be extracted with suitable solvents to provide solutions containing LiPO₂F₂ and LiPF₆ which can be applied for the manufacture of Li ion batteries, Li-air batteries and Li-sulfur batteries. Equimolar mixtures comprising LiPO₂F₂ and LiPF₆ are also described, as well as a method for the manufacture of electrolyte compositions obtained by the extraction of equimolar mixtures comprising LiPO₂F₂ and LiPF₆.

This application claims priority to European patent application No. 11177718.1 filed on 16 Aug. 2011, the whole content of this application being incorporated herein by reference for all purposes.

The present invention relates to a method for the manufacture of mixtures containing LiPO₂F₂ and LiPF₆ comprising a step of reacting phosphoryl fluoride (POF₃) and lithium fluoride (LiF). The present invention is also directed to solid LiPO₂F₂ in the form of needles.

Lithium difluorophosphate, LiPO₂F₂, is useful as electrolyte salt for an electrolyte composition further comprising LiPF₆. Thus, EP-A-2 065339 discloses how to manufacture a mixture of LiPF₆ and LiPO₂F₂ from a halide other than a fluoride, LiPF₆ and water. The resulting salt mixture, dissolved in aprotic solvents, is used as an electrolyte solution for lithium ion batteries. EP-A-2 061 115 describes the manufacture of LiPO₂F₂ from P₂O₃F₄ and Li compounds, and the manufacture of LiPO₂F₂ from LiPF₆ and compounds with a Si—O—Si bond, e.g. siloxanes. US 2008-305402 and US 2008/102376 disclose the manufacture of LiPO₂F₂ from LiPF₆ with a carbonate compound; according to US 2008/102376, LiPF₆ decomposes at 50° C. and above under formation of PF₅; according to other publications, PF₅ is only formed at and above the melting point of LiPF₆ (˜190° C.).

However, the above methods are technically difficult, and the starting material, LiPF₆, is expensive and thus its use increases the production cost. Since LiPF₆ is used as electrolyte salt together with LiPO₂F₂, it is ineffective to produce LiPO₂F₂ at the cost of LiPF₆. A process would be desirable which produces both LiPO₂F₂ and LiPF₆. Consequently, there has been a need to develop new processes, which are capable of avoiding the drawbacks indicated above.

Object of the present invention is to provide LiPO₂F₂ together with LiPF₆ in a technically feasible and economical manner. Another object of the present invention is to provide access to solutions containing both LiPF₆ and LiPO₂F₂ in an easy manner. These objects and other objects are achieved by the invention as outlined in the patent claims.

According to one aspect of the present invention, the method of the invention for the manufacture of a mixture comprising approximately equimolar amounts of LiPO₂F₂ and LiPF₆ comprises a step of reacting LiF and POF₃.

### BRIEF DESCRIPTION OF THE DRAWING

FIG. 1 shows an XRD spectrum of the product obtained from the reaction of LiF and POF₃ having peaks “a” indicating LiPF₆, peaks “b” indicating LiPO₂F₂ and peaks “c” indicating LiF.

LiF is a comparably cheap, easy to be purified starting material which is commercially available, e.g. from Chemetall GmbH, Germany. Phosphoryl fluoride (POF₃) can be obtained commercially, e.g. from ABCR GmbH & Co. KG. If desired, POF₃ can be manufactured from POCl₃ and fluorinating agents, for example, HF, ZnF₂ or amine-HF adducts. POF₃ produced can be purified by distillation. The reaction equation is

2POF₃+2LiF→LiPO₂F₂+LiPF₆ (I)

Consequently, the reaction according to equation (I) produces two valuable products. A technical advantage is that LiF can be dried easily which reduces the risk of hydrolysis especially of LiPF₆.

The method may comprise further steps, e.g. a step to provide a solution comprising LiPO₂F₂ and LiPF₆, one or more steps to obtain purified LiPO₂F₂ as described below, and other steps.

The reaction of the invention can be performed as a gas-solid reaction by passing POF₃ through a bed of LiF or by reacting both constituents in an autoclave. If desired, the LiF can be suspended in an aprotic organic solvent, and/or the POF₃ can be introduced dissolved in an aprotic organic solvent, and accordingly in this case, a gas-liquid-solid reaction or a liquid-solid reaction is performed. Suitable solvents for POF₃ are, for example, ether compounds, e.g. diethyl ether, and organic solvents which are useful as solvents in lithium ion batteries; many examples of such solvents, for example, especially organic carbonates, but also lactones, formamides, pyrrolidinones, oxazolidinones, nitroalkanes, N,N-substituted urethanes, sulfolane, dialkyl sulfoxides, dialkyl sulfites, acetates, nitriles, acetamides, glycol ethers, dioxolanes, dialkyloxyethanes, trifluoroacetamides, are given below.

In other embodiments, POF₃ is introduced into the reactor in complex form, especially in the form of a donor-acceptor complex such as POF₃-amine complexes. Those complexes include POF₃-pyridine, POF₃-trietylamine, POF₃-tributylamine, POF₃-DMAP(4-(dimethylamino) pyridine), POF₃-DBN(1,5-diazabicyclo[4.3.0]non-5-ene), POF₃-DBU(1,8-diazabicyclo[5.4.0]undec-7-ene), and POF₃-methylimidazole. In specific embodiments, a separate vessel can be used to supply POF₃ to the reactor vessel. POF₃ is preferably introduced into the reactor in gaseous form.

Preferably, the reaction is performed in the absence of water or moisture. As mentioned above, LiF may be dried before being introduced into the reaction. Alternatively or additionally, the reaction may be performed at least for a part of its duration in the presence of an inert gas; dry nitrogen is very suitable, but other dry inert gases may be applied, too. The reaction can be performed in an autoclave-type vessel or in other reactors. It is preferred to perform the reaction in apparatus made from steel or other materials resistant against corrosion, e.g. in reactors made of or clad with Monel metal.

LiF is preferably applied in the form of small particles, e.g. in the form of a powder.

Preferably, no HF is added to the reaction mixture. Preferably, no difluorophosphoric acid is added to the reaction mixture. Preferably, equal to or more than 80%, more preferably, equal to or more than 85%, and most preferably, 100% of the P content in the mixture of LiPO₂F₂ and LiPF₆ produced originate from POF₃.

The molar ratio of POF₃ to LiF ideally is 1:1. A preferred minimum for the ratio of POF₃ and LiF is 0.9:1. If it is lower, the yield is respectively lower, and unreacted LiF will be present in the formed reaction mixture. The molar ratio of POF₃ to LiF is preferably equal to or greater than 1:1. Preferably, it is equal to or lower than 5:1, more preferably, equal to or lower than 2:1. It could even be greater than 5:1 but either a lot of POF₃ is lost, or it must be recycled which needs additional apparatus parts and consumes energy.

The reaction time is selected such that the desired degree of conversion is achieved. Often, a reaction time of 1 second to 5 hours gives good results for the reaction. A preferred reaction time is 0.5 to 2 hours, most preferably of around 1 hour gives good results. The reaction speed is very fast.

The reaction temperature is preferably equal to or higher than 0° C. Preferably, the reaction temperature is equal to or lower than 100° C.

The reaction temperature is preferably equal to or higher than ambient temperature (25° C.), more preferably, equal to or higher than 40° C. The reaction temperature is preferably equal to or lower than 90° C., more preferably, equal to or lower than 70° C. A preferred range of temperature is from the reaction is performed at a temperature from 25 to 90° C., especially from 40 to 70° C.

If desired a reactor can be applied with internal heating or cooling means, or external heating or cooling means. It may have, for example, lines or pipes with a heat transfer agent like water.

The reaction between POF₃ and LiF may be performed at ambient pressure (1 bar abs.). Preferably, the reaction is performed at a pressure higher than 1 bar (abs.), and more preferably at a pressure higher than 3 bar (abs.). Preferably, the pressure is equal to or lower than 10 bar (abs), and more preferably, it is equal to or lower than 5 bar (abs). As the reaction proceeds, POF₃ is consumed, and the pressure may consequently be decreasing, in an autoclave for example. If POF₃ is introduced into the reaction continuously, a pressure drop indicates that the reaction is still progressing.

The reaction of POF₃ with LF can be performed batch wise, for example, in an autoclave. The reactor may have internal means, e.g. a stirrer, to provide a mechanical impact on the surface of the solid particles of LiF to remove reaction product from the surface and provide an unreacted fresh surface. It is also possible to shake or rotate the reactor itself.

Alternatively, the reaction can be performed continuously, for example, in a flow reactor. For example, the LiF may be provided in the form of a bed; POF₃ may be passed through this bed until a “breakthrough” of POF₃ is observed indicating the end of the reaction. If desired, dry inert gas like nitrogen or noble gases may be passed through the LiF bed to remove oxygen, moisture or both before performing the reaction.

If the reaction is performed continuously, for example, LiF may be kept in the form of a bed in a flow reactor, e.g. as a fluidized bed, and POF₃ is continuously passed through the bed. Continuously, POF₃ and fresh LiF may be introduced into the reactor, and continuously, reaction product may be withdrawn from the reactor.

If it is desired to separate LiPO₂F₂ and LiPF₆, the reaction might be performed in an aprotic solvent since LiPF₆ is much better soluble in these solvents than LiPO₂F₂; LiPF₆ will be dissolved predominantly and together with a minor amount of LiPO₂F₂ and can be removed in the solution. The solution containing dissolved LiPF₆ and LiPO₂F₂ is a valuable product per se as described below. Solid LiPO₂F₂ forms a solid residue which can be purified as described below. Thus, the reaction between POF₃ and LiF and the subsequent separation of formed LiPF₆ in the form of a valuable solution containing LiPF₆ and LiPO₂F₂, and a solid residue of LiPO₂F₂ (which can be further purified) can be performed in the same reactor in a kind of “1-pot process”.

If desired, after termination of the reaction, a vacuum may be applied, or dry inert gas like nitrogen or noble gases may be passed through the formed LiPO₂F₂ and LiPF₆, to remove HF, moisture or solvents if they had been used, or residual POF₃.

The resulting reaction mixture comprises approximately equimolar amounts of LiPO₂F₂ and LiPF₆ and is present in solid form if no solvent is used. If desired, the solid may be comminuted, e.g. milled, to provide a larger contact surface if it is intended to dissolve constituents of it.

The term “approximately” in the context of the “approximately equimolar amounts” shall denote a mixture of LiPO₂F₂ and 1.2 LiPF₆ consisting of 40 to 60 mol % LiPO₂F₂ and 40 to 60 mol % LiPF₆, preferably a mixture of LiPO₂F₂ and LiPF₆ consisting 45 to 55 mol % LiPO₂F₂ and 45 to 55 mol % LiPF₆, more preferably 49 to 51 mol % LiPO₂F₂ and 49 to 51 mol % LiPF₆.

The most reasonable way for a work up of the solid reaction mixture containing LiPO₂F₂ and LiPF₆ is to add an organic solvent, especially a solvent which is suitable as electrolyte solution for Li ion batteries, Li air batteries and Li sulfur batteries, when containing dissolved LiPF₆ and LiPO₂F₂. A lot of such solvents are given below. The best mode is to apply an aprotic polar solvent which dissolves LiPF₆ much better than LiPO₂F₂.

For fields of application wherein equimolar mixtures of LiPO₂F₂ and LiPF₆ may be applied, the reaction mixture can be applied without further work-up; alternatively, any moisture, HF or residual POF₃ may be removed by applying a vacuum, if desired, at elevated temperatures, e.g. at temperatures above 100° C. or even above 150° C., but preferably not higher than 200° C.

In view of the common use of LiPF₆ as electrolyte salt and the use of LiPO₂F₂ as electrolyte salt additive in Li ion batteries, Li air batteries and Li sulfur batteries wherein LiPF₆ is often dissolved to provide a 1-molar solution, and LiPO₂F₂ is dissolved in an amount to provide a concentration of 1 to 2% by weight, a preferred alternative of working up the reaction mixtures is to extract the mixture with a solvent used for the mentioned type of batteries. The concentration of LiPF₆ in the extract is usually much higher than the concentration of LiPO₂F₂. This is very advantageous in situations where en electrolyte solution such as the one mentioned above with a 1-molar amount of LiPF₆ and with as little as 1 to 2% by weight of LiPO₂F₂ is desired containing much more LiPF₆ than LiPO₂F₂. The actual concentration can be altered by adding LiPF₆, LiPO₂F₂ and/or by adding solvent or removing solvent, e.g. by applying a vacuum.

Often, the aprotic organic solvent is selected from the group of ketones, nitriles, formamides, dialkyl carbonates (which are linear) and alkylene carbonates (which are cyclic), and wherein the term “alkyl” denotes preferably C1 to C4 alkyl, the term “alkylene” denotes preferably C2 to C7 alkylene groups, including a vinylidene group, wherein the alkylene group preferably comprises a bridge of 2 carbon atoms between the oxygen atoms of the —O—C(O)—O— group; Dimethyl formamide, carboxylic acid amides, for example, N,N-dimethyl acetamide and N,N-diethyl acetamide, acetone, acetonitrile, linear dialkyl carbonates, e.g. dimethyl carbonate, diethyl carbonate, methyl ethyl carbonate, cyclic alkylene carbonates, e.g. ethylene carbonate, propylene carbonate, and vinylidene carbonate, are suitable solvents.

Dimethyl carbonate and propylene carbonate are among the preferred solvents for reaction mixtures because LiPO₂F₂ is at least fairly soluble in these solvents which are very well suited for use in Li ion batteries. Other very suitable solvents are ethylene carbonate (EC), ethyl methyl carbonate (EMC), propylene carbonate, ethyl acetate, diethyl carbonate, a mixture of dimethyl carbonate and propylene carbonate (PC), acetonitrile, dimethoxyethane and acetone. The solubility of LiPO₂F₂ in these solvents at ambient temperature is compiled in the following table 1.

TABLE 1
Solubility of LiPO₂F₂ in certain solvents

| Solvent | Solubility of LiPO₂F₂ [g/100 g solvent] |
|---|---|
| Diethyl carbonate | 0.4 |
| Dimethyl carbonate/propylene | 0.4 |
| carbonate (1:1 v/v) | |
| Acetonitrile | 2.8 |
| Propylene carbonate | 3 |
| Acetone | 20 |
| Dimethoxyethane | 37 |

The solubility of LiPO₂F₂ in acetonitrile and especially in dimethoxyethane and acetone is remarkably high; in the context of the present invention, these solvents are useful to provide solutions of LiPO₂F₂ and LiPF₆ with a high concentration also of LiPO₂F₂. It has to be noted, however, that acetone is not very well suited as a solvent for Li ion batteries.

The solubility of LiPO₂F₂ in dimethoxyethane is even higher than in acetone. Dimethoxyethane was considered as solvent or solvent additive for Li ion batteries. Thus, dimethoxyethane can be used to provide solutions with a high concentration both of LiPF₆ and of LiPO₂F₂.

Solutions of LiPF₆ and LiPO₂F₂ in dimethyl carbonate, propylene carbonate and mixtures thereof—which dissolve LiF at most in neglectable amounts—are especially suitable for the manufacture of battery electrolytes.

Besides the solvents mentioned above, other solvents which often are used as electrolyte solvent of Li ion batteries can be applied a single solvent or as a component of solvent mixtures. For example, fluorinated solvents, e.g. mono-, di-, tri- and/or tetrafluoroethylene carbonate, are very suitable. Other suitable solvents are lactones, formamides, pyrrolidinones, oxazolidinones, nitroalkanes, N,N-substituted urethanes, sulfolane, dialkyl sulfoxides, dialkyl sulfites, as described in the publication of M. Ue et al. in J. Electrochem. Soc. Vol. 141 (1994), pages 2989 to 2996, or trialkylphosphates or alkoxyesters, as described in DE-A 10016816.

Alkylene carbonates may be applied as solvent or solvent additive. Pyrocarbonates are also useful, see U.S. Pat. No. 5,427,874. Alkyl acetates, for example, ethyl acetate, N,N-disubstituted acetamides, sulfoxides, nitriles, glycol ethers and ethers are useful, too, see EP-A-0 662 729. Often, mixtures of these solvents are applied. Dioxolane is a useful solvent, see EP-A-0 385 724. For lithium bis-(trifluoromethansulfonyl)imide, 1,2-bis-(trifluoracetoxy)ethane and N,N-dimethyl trifluoroacetamide, see ITE Battery Letters Vol. 1 (1999), pages 105 to 109, are applicable as solvent. In the foregoing, the term “alkyl” preferably denotes saturated linear or branched C1 to C4 alkyl groups; the term “alkylene” denotes preferably C2 to C7 alkylene groups, including a vinylidene group, wherein the alkylene group preferably comprises a bridge of 2 carbon atoms between the oxygen atoms of the —O—C(O)—O— group, thus forming a 5-membered ring.

Fluorosubstituted compounds, for example, fluorinated carbonic esters which are selected from the group of fluorosubstituted ethylene carbonates, fluorosubstituted dimethyl carbonates, fluorosubstituted ethyl methyl carbonates, and fluorosubstituted diethyl carbonates are also suitable solvents for dissolving LiPO₂F₂ or LiPF₆, respectively. They are applicable in the form of mixtures with non-fluorinated solvents. The non-fluorinated organic carbonates mentioned above are for example very suitable.

Preferred fluorosubstituted carbonates are monofluoroethylene carbonate, 4,4-difluoro ethylene carbonate, 4,5-difluoro ethylene carbonate, 4-fluoro-4-methyl ethylene carbonate, 4,5-difluoro-4-methyl ethylene carbonate, 4-fluoro-5-methyl ethylene carbonate, 4,4-difluoro-5-methyl ethylene carbonate, 4-(fluoromethyl)-ethylene carbonate, 4-(difluoromethyl)-ethylene carbonate, 4-(trifluoromethyl)-ethylene carbonate, 4-(fluoromethyl)-4-fluoro ethylene carbonate, 4-(fluoromethyl)-5-fluoro ethylene carbonate, 4-fluoro-4,5-dimethyl ethylene carbonate, 4,5-difluoro-4,5-dimethyl ethylene carbonate, and 4,4-difluoro-5,5-dimethyl ethylene carbonate; dimethyl carbonate derivatives including fluoromethyl methyl carbonate, difluoromethyl methyl carbonate, trifluoromethyl methyl carbonate, bis(fluoromethyl)carbonate, bis(difluoro)methyl carbonate, and bis(trifluoro)methyl carbonate; ethyl methyl carbonate derivatives including 2-fluoroethyl methyl carbonate, ethyl fluoromethyl carbonate, 2,2-difluoroethyl methyl carbonate, 2-fluoroethyl fluoromethyl carbonate, ethyl difluoromethyl carbonate, 2,2,2-trifluoroethyl methyl carbonate, 2,2-difluoroethyl fluoromethyl carbonate, 2-fluoroethyl difluoromethyl carbonate, and ethyl trifluoromethyl carbonate; and diethyl carbonate derivatives including ethyl (2-fluoroethyl)carbonate, ethyl (2,2-difluoroethyl)carbonate, bis(2-fluoroethyl)carbonate, ethyl (2,2,2-trifluoroethyl)carbonate, 2,2-difluoroethyl 2′-fluoroethyl carbonate, bis(2,2-difluoroethyl)carbonate, 2,2,2-trifluoroethyl 2′-fluoroethyl carbonate, 2,2,2-trifluoroethyl 2′,2′-difluoroethyl carbonate, and bis(2,2,2-trifluoroethyl)carbonate.

Carbonate esters having both an unsaturated bond and a fluorine atom (hereinafter abbreviated to as “fluorinated unsaturated carbonic ester”) may also be used as solvent to dissolve predominantly LiPF₆ and a minor amount of LiPO₂F₂. The fluorinated unsaturated carbonic esters include any fluorinated unsaturated carbonic esters that do not significantly impair the advantages of the present invention.

Examples of the fluorinated unsaturated carbonic esters include fluorosubstituted vinylene carbonate derivatives, fluorosubstituted ethylene carbonate derivatives substituted by a substituent having an aromatic ring or a carbon-carbon unsaturated bond, and fluorosubstituted allyl carbonates.

Examples of the vinylene carbonate derivatives include fluorovinylene carbonate, 4-fluoro-5-methylvinylene carbonate and 4-fluoro-5-phenylvinylene carbonate.

Examples of the ethylene carbonate derivatives substituted by a substituent having an aromatic ring or a carbon-carbon unsaturated bond include 4-fluoro-4-vinylethylene carbonate, 4-fluoro-5-vinylethylene carbonate, 4,4-difluoro-4-vinylethylene carbonate, 4,5-difluoro-4-vinylethylene carbonate, 4-fluoro-4,5-divinylethylene carbonate, 4,5-difluoro-4,5-divinylethylene carbonate, 4-fluoro-4-phenylethylene carbonate, 4-fluoro-5-phenylethylene carbonate, 4,4-difluoro-5-phenylethylene carbonate, 4,5-difluoro-4-phenylethylene carbonate and 4,5-difluoro-4,5-diphenylethylene carbonate.

Examples of the fluorosubstituted phenyl carbonates include fluoromethyl phenyl carbonate, 2-fluoroethyl phenyl carbonate, 2,2-difluoroethyl phenyl carbonate and 2,2,2-trifluoroethyl phenyl carbonate.

Examples of the fluorosubstituted vinyl carbonates include fluoromethyl vinyl carbonate, 2-fluoroethyl vinyl carbonate, 2,2-difluoroethyl vinyl carbonate and 2,2,2-trifluoroethyl vinyl carbonate.

Examples of the fluorosubstituted allyl carbonates include fluoromethyl allyl carbonate, 2-fluoroethyl allyl carbonate, 2,2-difluoroethyl allyl carbonate and 2,2,2-trifluoroethyl allyl carbonate.

The extraction of LiPF₆ and LiPO₂F₂ from the reaction mixture to provide solutions having a major amount of LiPF₆ and a minor amount of LiPO₂F₂ may be performed in a known manner, for example, by stirring the reaction mixture with the solvent (extractant) directly in the reactor, or after removing the reaction mixture from the reactor and optionally crushing or milling, in a suitable vessel, e.g. a Soxhlet vessel. The extraction liquid contains the Li salts and may be further processed.

The liquid phase containing a major amount of LiPF₆ and a minor amount of LiPO₂F₂ dissolved in the solvent can be separated from the non-dissolved solid LiPO₂F₂ in a known manner. For example, the solution can be passed through a filter, or it can be decanted, or the separation can be effected by centrifugation.

If desired, highly pure solid LiPO₂F₂ can be recovered. For example, the residue containing solid LiPO₂F₂ is dissolved, and the respective solutions can be cooled such that solid LiPO₂F₂ precipitates, or a non-polar organic liquid might be added to cause crystallization. For example, LiPO₂F₂ may be dissolved in dimethoxyethane, and a hydrocarbon, e.g., hexane, may be added. LiPO₂F₂ precipitates in the form of a gel-like solid. If acetone is applied as solvent, it is possible to obtain a 20% by concentration of LiPO₂F₂. Upon cooling to 0° C., solid, needle-like LiPO₂F₂ precipitates.

Accordingly, the invention provides a method for obtaining purified LiPO₂F₂ wherein in a first step, LiPF₆ is predominantly separated from the mixture comprising LiPO₂F₂ and LiPF₆ by extracting the mixture with a solvent which predominantly dissolves LiPF₆, and
a) the remaining undissolved LiPO₂F₂ is dissolved in a polar aprotic solvent, until at least 90% of the saturation concentration is reached, the solvent is cooled to precipitate LiPO₂F₂, the precipitated LiPO₂F₂ is separated from the solvent and subjected to a treatment to remove any solvent, or
b) the remaining undissolved LiPO₂F₂ is dissolved in polar aprotic solvent, a non-polar organic solvent is added to precipitate dissolved LiPO₂F₂, the precipitated LiPO₂F₂ is separated from the solvent, and subjected to a treatment, e.g. heating and/or applying a vacuum, to remove remaining solvent.

Preferably, the solvent in step a) is acetone.

Preferably, in step b), the aprotic solvent is dimethoxyethane and the non-polar solvent is a hydrocarbon, preferably hexane.

If desired, the LiPO₂F₂ in the reaction mixture remaining undissolved can be stored or can be subjected to further purification treatments to obtain pure solid LiPO₂F₂, e.g. as described above by dissolution in dimethoxyethane, acetone or other solvents. Adhering solvent can be removed by evaporation which may preferably be performed in a vacuum depending on the boiling point of the adhering solvent or solvents.

The dissolved LiPO₂F₂ can be recovered from the solution by evaporation of the solvent to obtain pure solid LiPO₂F₂. This can be performed in a known manner. For example, adhering solvent can be removed by evaporation which may preferably be performed in a vacuum depending on the boiling point of the adhering solvent or solvents.

Isolated solid LiPO₂F₂ can be re-dissolved in any suitable solvent or solvent mixture. The solvents mentioned above, including acetone and dimethoxyethane, are very suitable. Since its main use is as electrolyte salt or salt additive in the field of lithium ion batteries, it may be preferably dissolved in a water-free solvent used for the manufacture of the electrolyte solutions of lithium ion batteries. Such solvents are disclosed above.

Equimolar mixtures of LiPF₆ and LiPO₂F₂, both valuable compounds and useful as mixture or, as described above, separately after isolation can be obtained by the process of the invention from cheap starting materials. Pure needle-like LiPO₂F₂ can be obtained from a concentrated solution of LiPO₂F₂ in acetone and subsequent cooling.

An advantage of using POF₃ is that it can be prepared essentially free of HCl even in chlorine-fluorine exchange reactions. Since the boiling point (b.p.) of POF₃, −40° C., is higher than that of HCl (the boiling point of HCl is −85.1° C.), a simple distillation or condensation technique under pressure can be used for purification of the POF₃ intermediate product, which makes the present process more economical.

Another aspect of the present invention concerns equimolar mixtures of LiPO₂F₂ and LiPF₆. These mixtures, as shown above, a valuable sources for electrolyte solutions for electrolyte compositions of batteries and for the manufacture of needle-like LiPO₂F₂.

Still another aspect of the invention concerns needle-like solid LiPO₂F₂. The needles have a ratio of length to diameter of equal to or more than 3. LiPO₂F₂ is likewise a valuable product because it can be used as additive in battery electrolyte compositions as mentioned above, and, being in crystalline form, is easy to handle.

Should the disclosure of any of the patents, patent applications, and publications that are incorporated herein by reference be in conflict with the present description to the extent that it might render a term unclear, the present description shall take precedence.

The following examples will describe the invention in further detail without the intention to limit it.

### EXAMPLE 1

### Manufacture of an Equimolar Mixture of LiPO₂F₂ and LiPF₆

225 g of LiF (supplier: Aldrich) were introduced in a movable autoclave reactor and dried under vacuum (applying heat externally).

The closed reactor is started and performs movements to mechanically impact the solid starting material and improve the reaction, and the gaseous POF₃ is passed into the reactor through a PTFE tubing from a gas bottle provided with a pressure regulation valve. The addition speed was limited by keeping an overall reaction temperature (measured inside reactor) below 32° C. The pressure did not rise until end of the reaction due to the fast reaction between LiF and POF₃. An average feed rate of 74 g/h of POF₃ was possible while keeping the temperature inside the reactor below 32° C.

After 9 hours the pressure rose to around 4 atm and the system was kept under these conditions for two further hours. After that time, the reactor was evacuated and externally heated till the inner temperature reached 70° C.; the temperature was kept at that level for 2.5 hours.

The product was removed from the reactor in the form of a white powder, yielding a total mass of 730 g (mass gain: 730 g−225 g=505 g: equivalent to 4.9 mol POF₃).

Theoretical amount POF₃ (according to stoichiometry) for 225 g LiF (8.7 mol): 8.7 mol POF₃=905 g

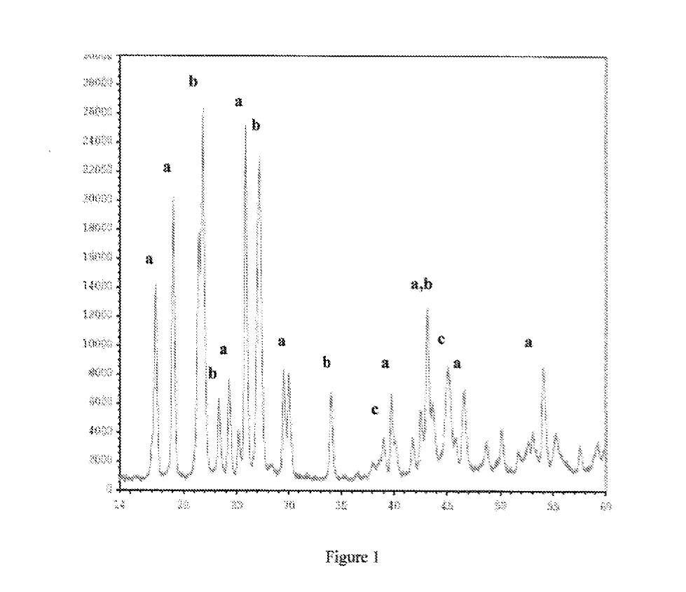

The XRD of the product after reaction is given in FIG. 1.

Peaks denoted as a indicate LiPF₆; peaks denoted as b indicate LiPO₂F₂; peaks denoted as c indicate LiF.

LiPF₆ shows 2-Theta values at 17; 19 (strong); 26 (strong); 29; 30; 40; 43; 45 and 54.

LiPO₂F₂ shows 2-Theta values at 21.5 (strong); 22.0; 23.5; 27.0 (strong); 34.2; 43.2.

LiF shows 2-Theta values at 39 and 44 (weak).

### EXAMPLE 2

### Manufacture of Needle-Like LiPO₂F₂

LiPO₂F₂ powder obtained in example 1 was dissolved in acetone to obtain a saturated solution. The solution was then cooled to 0° C. LiPO₂F₂ precipitated in the form of needles.

### EXAMPLE 3

### Electrolyte Solution for Lithium Ion Batteries, Lithium-Sulfur Batteries and Lithium-Oxygen Batteries

The solid of example 1 is extracted with a mixture of equimolar volumes of ethylene carbonate (“EC”) and propylene carbonate (“PP”) are mixed in amount such that a total volume of 1 liter is obtained. The resulting solution contains LiPF₆ and additionally about 0.5% by weight of LiPO₂F₂.

### EXAMPLE 4

### Electrolyte Solution for Lithium Ion Batteries, Lithium-Sulfur Batteries and Lithium-Oxygen Batteries

The needles of example 2 are dissolved in a mixture of equimolar volumes of ethylene carbonate (“EC”) and propylene carbonate (“PP”), mixed in amount such that a total volume of 1 liter is obtained. The resulting solution contains about 0.5% by weight of LiPO₂F₂.

1.-10. (canceled)

11. An approximately equimolar mixture consisting of LiPO₂F₂ and LiPF₆.

12. The mixture of claim 11 consisting of 40 to 60 mol % LiPO₂F₂ and 40 to 60 mol % LiPF₆.

13. Crystalline LiPO₂F₂.

14. (canceled)

15. (canceled)

16. The crystalline LiPO₂F₂ of claim 13, wherein the crystalline LiPO₂F₂ is needle-like.

17. The crystalline LiPO₂F₂ of claim 16, wherein the crystals have a ratio of length to diameter of equal to or more than 3.

18. A method for preparing an electrolyte solution, the method comprising contacting the crystalline LiPO₂F₂ of claim 13 with at least one solvent for Li ion batteries, Li air batteries and Li-sulfur batteries.
